(19) United States
(12) Patent Application Publication
(10) Pub. No.: US 2022/0185009 A1
(43) Pub. Date: Jun. 16, 2022

(54) INFLATION INTEGRATED HUBCAP

(71) Applicant: Equalaire Systems, Inc., Corpus Christi, TX (US)

(72) Inventors: Dane Henry, Windcrest, TX (US); Steven R. Miller, San Antonio, TX (US); James Sharkey, San Antonio, TX (US); Mark Kevin Hennig, Corpus Christi, TX (US)

(21) Appl. No.: 17/599,367

(22) PCT Filed: Mar. 28, 2020
(86) PCT No.: PCT/US2020/025581

§ 371 Date: Sep. 28, 2021

Related U.S. Application Data
(60) Provisional application No. 62/825,558, filed on Mar. 28, 2019.

(51) Int. Cl. B60B 7/00; B60C 23/00

(52) U.S. Cl. CPC B60B 7/0013; B60C 23/007; B60C 23/00336; B60C 23/00327

(57) ABSTRACT

A rotary union is configured for removable disposition into the central bore of a hubcap through an orifice in the outboard face of the hubcap. The hubcap includes a fluid channel extending from the central bore to the exterior of the hubcap. The rotary union includes a port through which fluid may flow into the fluid channel when the rotary union is disposed in the central bore.

### CROSS-REFERENCE TO RELATED APPLICATION

This application claims priority to U.S. Provisional Patent Application 62/825,558 entitled “Tire Inflation Hubcap with Rotary Union” filed Mar. 28, 2019, which is hereby entirely incorporated herein by reference.

### FIELD

This application relates generally to vehicle tire inflation systems and the components therefor.

### BACKGROUND

There exists a need for a method and apparatus for improved integration of a rotary union with a hubcap for ready accessibility.

### SUMMARY

A rotary union comprising a round rotor body having a sealed first end and a second end forming a first fluid channel, the rotor body having a port extending therethrough to permit fluid to flow from the first fluid channel out of the rotor body; a tubular member having a first end sealingly and rotatably disposed in the fluid channel at the second end of the rotor body; the rotor body being configured for removable disposition into the interior of a hubcap, the hubcap having an outboard face forming an orifice at the center thereof, the hubcap having a central bore disposed wholly in the hubcap interior and aligned with the orifice, the central bore being configured to receive the second end of the rotor body when the rotor body is introduced into the hubcap interior through the orifice, the hubcap comprising a second fluid channel extending from an exterior surface of the hubcap to the central bore; and the rotor body being further configured for disposition in the central bore such that the tubular member extends into the hubcap interior and fluid may flow from the port into the second fluid channel.

A vehicle hubcap adapted for use with a tire inflation system, the hubcap comprising a round cap body forming a hollow interior, the cap body having a first end comprising a solid outboard face, the outboard face forming an orifice at the center thereof, the cap body having an open second end configured for removable mounting to a vehicle hub; a central bore disposed wholly within the hubcap interior and aligned with the orifice; a fluid channel extending from an exterior surface of the cap body to the central bore, the fluid channel being configured to connect to an air hose at the exterior surface; the central bore being configured to receive a rotary union when the rotary union is introduced into the interior space through the orifice, the rotary union comprising a rotor body and a tubular member sealingly and rotatably coupled to the rotor body, the rotor body having a port extending therethrough to permit fluid to flow from the rotor union; and the central bore being configured to receive the rotor body such that the tubular member extends into the hubcap interior and fluid may flow from the port of the rotor body to the fluid channel.

A method of installing a rotary union in a hubcap, the rotary union comprising a fluid port, the hubcap comprising an outboard face having an orifice centrally formed therein, a plug removably disposed in the orifice, a central bore disposed in the interior of the hubcap and aligned with the orifice, and a fluid channel extending from the central bore to an exterior of the hubcap, the method comprising removing the plug from the orifice; inserting a rotary union through the orifice and advancing the rotary union into the central bore so as to align the fluid port with the fluid channel; and disposing the plug in the orifice.

### BRIEF DESCRIPTION OF THE DRAWINGS

FIG. 1 illustrates an embodiment of a wheel end having a hubcap adapted for use with a tire inflation system.

FIG. 2 illustrates an embodiment of a rotary union disposed in the central bore of a hubcap.

FIG. 3 illustrates another embodiment of a rotary union disposed in the central bore of a hubcap.

FIG. 4 illustrates a further embodiment of a rotary union disposed in the central bore of a hubcap under a hubcap vent plug.

FIG. 5 illustrates an embodiment of a rotary union disposed in the central bore of a hubcap.

FIG. 6 illustrates another embodiment of a rotary union disposed in the central bore of a hubcap.

FIG. 7 illustrates an embodiment of a rotary union disposed in the central bore of a hubcap.

FIG. 8 illustrates the rotary union embodiment of FIG. 7.

FIG. 9 illustrates perspective view of the embodiment of FIG. 8 having a vent shield and flapper installed thereon.

### DETAILED DESCRIPTION

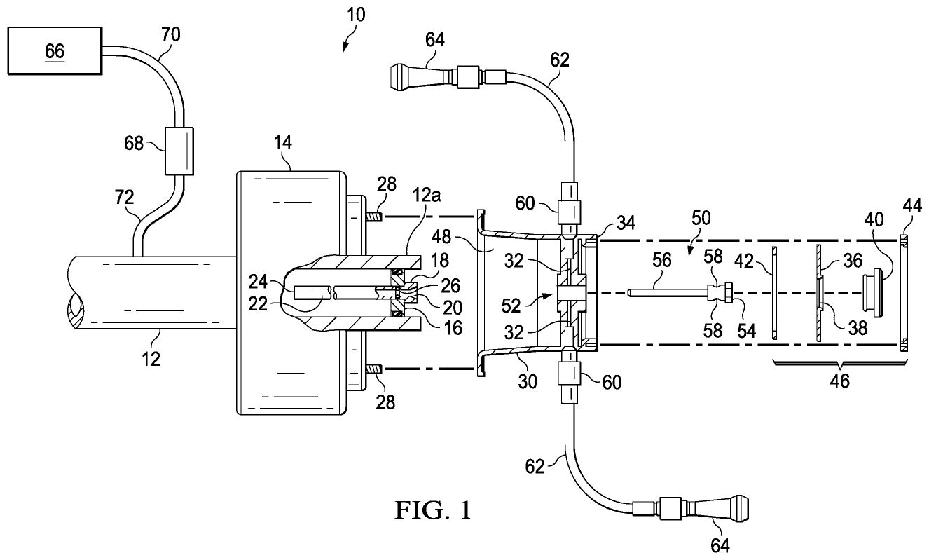

FIG. 1 illustrates one embodiment of a wheel end 10 of a vehicle, such as a commercial truck or trailer, configured to include tire inflation system components. Generally, the tire inflation components include a rotary union disposed so as to convey pressurized fluid from a vehicle-mounted fluid supply to rotating or rotatable tires.

In the example of FIG. 1, a vehicle axle 12 may have a hub 14 mounted thereto as is known in the art. The vehicle axle 12 may be hollow and sealed at each end. The end 12a of the axle 12 may be sealed with an axle plug 16, such as a press plug. The axle plug may seal the axle 12 such that the axle 12 may convey pressurized fluid at a pressure suitable for tire inflation.

A stator 18 may be sealingly mounted in the axle plug 16. The stator 18 comprises a stator channel 20 through which pressurized fluid may flow. The stator 18 may further comprise a tube 22 through which pressurized fluid may flow. A filter 24 may be disposed at or in the tube 22 so as to remove particles from the fluid before the fluid enters the stator 18. An annular seal 26, such as an o-ring or lip seal, is disposed circumferentially in the stator channel 20.

In other embodiments, a stator may comprise a fitting held in the end 12a of the axle at the end of a pressurized fluid conduit (not shown) disposed through the axle 12 and connected to a fluid pressure source. The fitting may comprise a stator channel and annular seal as described above.

The hub 14 comprises lugs 28 to which a hubcap 30 may be removably mounted. The hubcap 30 comprises one or more internal fluid channels 32 disposed in the interior of the hubcap 30 and radiating away from a center through which fluid, such as pressurized air, may be communicated. The hubcap 30 comprises a hubcap body 34 having on its outboard face a sight glass 36 or other solid surface. The sight glass 36 may be wholly or partially transparent to permit the conditions in the interior of the hubcap, such as lubricant fluid level, to be determined visually. The internal fluid channels 32 are disposed under the sight glass 36 in the interior 48 of the hubcap 30. An orifice 38 is provided in the outboard face of the hubcap 30, such as in the sight glass 36. The orifice 38 may be adapted to receive a vent plug or non-venting plug. In the disclosed embodiment, a vent plug 40 is disposed in the orifice 38, and is configured to release pressure from the interior 48 of the hubcap 30. The vent plug 40 may be configured to permit pressurized fluid to escape from the interior 48 of the hubcap 30 while substantially preventing environmental contaminants from entering the hubcap 30 interior 48.

The outboard face of the hubcap may comprise any solid surface sealing or enclosing the outside or free end of the hubcap. The outboard face may be formed as a unitary item of manufacture with the hubcap body, or may be a separate cover or disc removably or permanently mountable to the hubcap body.

The hubcap 30 may be sealed at hubcap body 34 circumference by a gasket 42, sight glass 36 and retainer ring 44. The gasket 42, sight glass 36 and retainer ring 44 may comprise a sight glass assembly 46 that may be sealingly mounted to the hubcap 30 by, e.g., screws (not shown).

In other embodiments, the vent plug 40 may be mounted in the retainer ring 44 and extend through the sight glass 36. The vent plug 40 may in some embodiments comprise a pressure relief valve or an opening to relieve fluid pressure that may build up in the hubcap 30. Such a vent plug 40 may, for example, be a Sentinel™ ESP plug or Sentinel™ ESP filter vent made by Stemco. In some embodiments, the hubcap may have one or more drains (not shown) disposed in the sidewall for the removal or addition of lubricant for the wheel hub.

A rotary union assembly 50 may be disposed in the interior 48 of the hubcap 30 and mounted to a central bore 52 of the hubcap 30. The central bore is disposed on the rotational axis of the hubcap 30. The rotary union assembly 50 comprises a rotor body 54 and a tubular member 56 having an end sealingly and rotatably disposed in the rotor body 54.

The rotor body 54 forms one or more fluid ports 58. The rotor body 54 is configured for sealing disposition in the central bore 52 such that the one or more ports 58 are placed in fluid communication with the internal fluid channels 32 of the hubcap 30.

The tubular member 56 is of sufficient length to extend into the stator 18 when the hubcap 30 is mounted to the hub 14. The tubular member 56 is thus translatable into the stator 18 so as to sealingly engage the annular seal 26. The tubular member 56 may, in some embodiments, rotate in the annular seal 26. Thus, the tubular member 56 may rotate in either or both of the stator 18 and the rotor body 54.

In further embodiments, the tube 22 may translate, rotate and/or pivot within the annular seal 26 in the stator, depending on the configuration of the tube 22. The tubular member 56 may comprise a flexible portion and a rigid portion. In other embodiments, the tubular member 56 may comprise an entirely flexible tube or an entirely rigid tube. A rotary union sealing interface may be formed by the tubular member 56 and the annular seal 26.

The annular seal 26 may be an o-ring, lip seal or any other suitable seal configuration, and may comprise a variety of materials, such as rubber, silicone, nylon, oilite or graphite.

When the rotary union assembly 50 is assembled to the hubcap 30 and the hubcap 30 is mounted to the hub 14, then a sealed fluid path is formed such that pressurized fluid may flow back and forth through the stator 18 into the tubular member 56 to the rotor body 54 and out through the one or more ports 58 to the hubcap 30 internal fluid channels 32. Each hubcap internal fluid channel may have a hose fitting 60 sealingly coupled thereto. An air hose 62 provides a sealed fluid connection between the hose fitting 60 and the valve stem 64 of a vehicle tire (not shown). Pressurized fluid may thus flow from the internal fluid channels 32 of the hubcap 30 to the tire, thus inflating the tire to a desired pressure.

Pressurized fluid may be provided by any suitable fluid pressure supply 66, such as a vehicle air brake air supply. A pressure regulator 68 may receive pressurized fluid from the fluid pressure supply 66 through conduit 70. A conduit 72 may convey pressurized fluid from the pressure regulator 68 to the axle 12. In some embodiments, the axle 12 may serve as a fluid conduit to convey the pressurized fluid from the conduit 72 to the stator 18. In other embodiments, the conduit 72 may extend through the axle 12 to a stator fitting as described above (not shown).

In the embodiment of FIG. 1, the rotary union assembly 50 can be disposed in and removed from the interior 48 of the hubcap 30 through the orifice 38. The vent plug 40 is removed, and a tool (not shown) may be inserted through the orifice 38 so as to engage the rotary union assembly 50. If the rotary union assembly 50 is threadably mounted to the hubcap 30, then the tool may threadably decouple the rotary union assembly 50 from the hubcap 30 for removal through the orifice 38. A new or repaired rotary union assembly 50 may then be inserted through the orifice 38 and secured to the hubcap 30. The vent plug 40 is then replaced.

Thus vent plug 40 may also serve as a protective cover for the rotary union assembly 50 wherein removal of the vent plug 40 advantageously reveals access to the rotary union assembly 50 for removal or maintenance of the rotary union assembly 50 without necessitating removal of the hubcap 30 from the hub 14 or draining much, if any, lubricant from the interior of the hubcap. Thus, a rotary union may be removed and installed from the hubcap while the hubcap contains lubricant, thus avoiding lubricant disposal, extra repair steps and mess.

The rotary union assembly 50 may thus be mounted to a hubcap 30 comprising internal fluid channels 32 disposed in the interior 48 of the hubcap 30. The hubcap 30 may comprise a hubcap body 34 having on its outboard face a sight glass 36 or other solid disk. The internal fluid channels 32 are disposed under the sight glass 36 in the interior 48 of the hubcap 30. In one embodiment, the rotary union assembly 50 may be removably mounted in the hubcap 30 so that the rotary union assembly 50 is completely contained within the space formed by the hubcap 30 and hub 14. The rotary union assembly 50 may be inserted into the hubcap 30 through an orifice 38 of the outboard wall (such as sight glass 36) of the hubcap 30 such that the rotary union assembly 50 may be inserted through the orifice 38 from the outboard face of the wall and is then accessible for removal without disengaging the hubcap 30 from the hub 14.

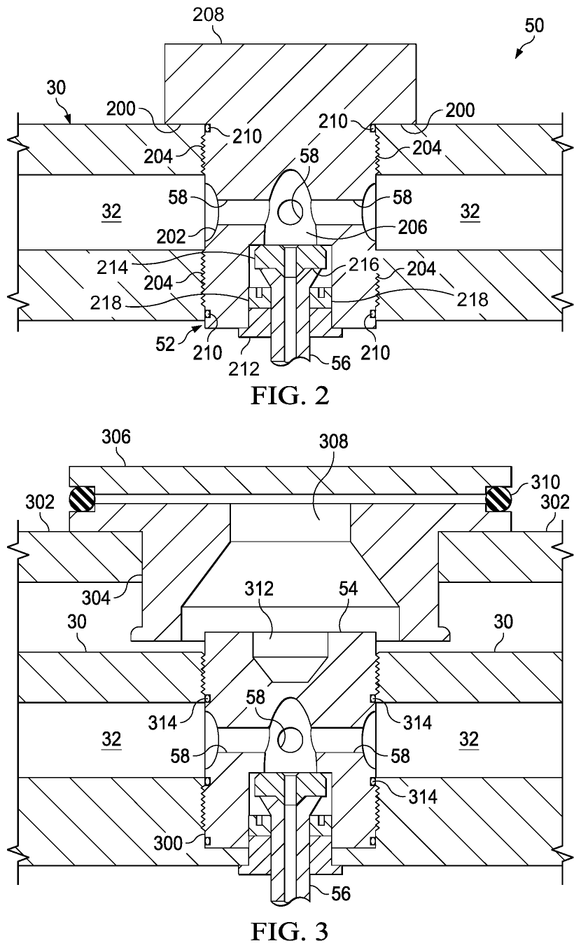

FIG. 2 provides further detail of the rotary union assembly 50. The rotor body 208 may be of a generally cylindrical shape with threads formed along the outer surface so as to threadably engage corresponding threads in the central bore 52 of the hubcap 30. The threaded portion may include a shoulder 200 at the distal end so as to ensure that the rotor body 208 is properly seated such that fluid ports 58 are aligned with the internal fluid channels 32 of the hubcap 30. In some embodiments, the rotor body 208 may comprise a fluid groove 202 to provide fluid communication among the ports 58 about the exterior of the rotor body 208. Such a fluid groove 202 may extend wholly or partly circumferentially around the exterior of the rotor body, and may permit the rotor body 208 to be coupled to the hubcap 30 without requiring alignment of ports 58 with the internal fluid channels 32 of the hubcap 30. In such embodiments, when the rotor body 208 is installed in the hubcap 30, fluid may flow from ports 58 of the rotor body 208 and through the fluid groove 202 to the internal fluid channels 32 of the hubcap 30.

In other embodiments, a fluid groove may be circumferentially provided in the inner diameter of the central bore to provide fluid communication among the one or more fluid ports 58 about the exterior of the rotor body 208.

In various embodiments, a rotor body may include a single fluid port, or may include a plurality of fluid ports. A single fluid port may provide fluid to one or more fluid channels in the hubcap. In other embodiments, the rotor body may include a number of fluid ports corresponding to the number of fluid channels provided in the hubcap.

In the embodiment of FIG. 2, the threaded portions 204 are shown as NPT threads. However, straight and other thread types may be used as well. Of course, any other suitable mounting means to couple the rotor body 208 to the hubcap 30 may be provided, such as keys and slots, friction fit, adhesive, crimping, and the like. The rotor body 208 may comprise a fluid chamber 206. The tubular member 56 may be assembled to the rotor body 208 by a telescope cap 212. The telescope cap 212 may be mounted to the rotor body 208 by any suitable means, such as friction fit, screw threads, adhesive or crimping, etc. The tubular member 56 may comprise a flared end that may be disposed within the fluid chamber 206. The flared end may prevent the tubular member 56 from sliding out of the telescope cap 212. A bearing 214 may be disposed between a lip 216 of the rotor body 208 and the flared end of the tubular member 56. The bearing may comprise any suitable material, such as graphite, nylon, oilite, Delrin, brass or any other material suitable for reducing wear or friction between the tubular member 56 and the rotor body. The tube may be sealed to the rotor body by an annular seal 218. The annular seal 218 may be an o-ring, lip seal or any other suitable seal configuration, and may comprise a variety of materials, such as rubber, silicone, nylon, oilite or graphite. The tube may rotate within either or both of the annular seals 26 (stator) and 218.

The tubular member 56 may comprise any suitable material or combination of materials, and may be rigid, flexible, or both. For example, tubular member 56 may comprise steel, brass, nylon, polycarbonate, acrylic, rubber, or any combination thereof. For example, the flared end of the tubular member 56 may comprise a steel tubular portion, and the stator end (not shown) may comprise a nylon tubular portion, and the nylon and steel portions may be coupled by any suitable means, such as a compression ring, screw threads, adhesive, friction fit, Presto-Lok fittings, and the like. A rigid tube may pivot within and/or translate through either or both of the annular seals 26 (stator) and 218, thus accommodating misalignment between the hub and axle, e.g., as may result from bearing play. A tube that is wholly or partially flexible may accommodate such misalignment by flexing. In some embodiments, the friction between annular seal 26 and the tube may be different from the friction between annular seal 218 and the tube, thus allowing the tube to rotate at a different speed than the hubcap. In some embodiments, the friction between an annular seal 26 or 218 may be sufficient to prevent rotation of the tube in such seal, which may result in the tube either rotating as fast as the hubcap (i.e., the tube will not rotate with respect to the hubcap), or not rotating at all (i.e., the tube is stationary with respect to the hubcap).

In further embodiments, one or more additional annular seals may be disposed in the stator or rotor body to further seal the tubular member 56 in the stator or rotor body.

The rotor body 208 may be sealed to the central bore 52 of the hubcap by one or more annular seals 210 disposed between the central bore 52 and the rotor body 208. The annular seals may be o-rings, lip seals or any other suitable seal configuration, and may comprise a variety of materials, such as rubber, silicone, nylon, oilite or graphite.

In some embodiments, such as in FIG. 3, the rotor body 54 may be formed without a shoulder and configured to seat in a blind socket 300 forming a central bore of the hubcap 30 so as to ensure proper alignment of the fluid ports 58 with the internal fluid channels 32 of the hubcap 30. The blind socket 300 is configured such that seating the rotor body 54 into the blind socket 300 is sufficient to align the fluid ports 58 with the internal fluid channels 32 of the hubcap 30. A tool receptacle 312 may be formed in the rotor body 54 and configured to receive a tool for removal of the rotor body 54 from the hubcap 30. One or more annular seals 314 may seal the rotor body 54 to the hubcap 30.

As may be seen in the embodiment of FIG. 3, the rotor body 54 may be disposed inside the hubcap 30 and be accessible from the outer face 302 of the hubcap 30 through a vent orifice 304. A vent plug 306 may be disposed in the vent orifice 304. A vent channel 308 provides a pathway for pressurized fluid to escape from the interior 48 of the hubcap 30. A gland 310, such as an o-ring, may provide a one-way valve to seal the vent channel 308 from environmental contaminants.

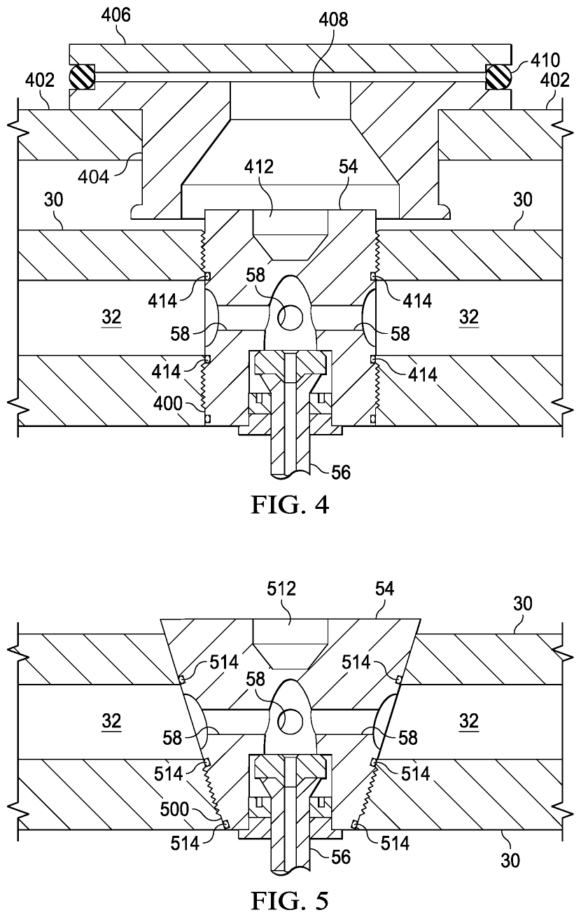

In other embodiments, such as in FIG. 4, the rotor body 54 may be installed in an open socket 400 forming a central bore of the hubcap 30 so as to ensure proper alignment of the one or more fluid ports 58 with the internal fluid channels 32 of the hubcap. The open socket configuration gives the installer more freedom to make minor adjustments to the disposition of the rotor body 54 in the central bore as needed to better align the ports 58 with the internal fluid channels 32 of the hubcap 30. A tool receptacle 412 may be formed in the rotor body 54 and configured to receive a tool for removal of the rotor body 54 from the hubcap 30. One or more annular seals 414 may seal the rotor body 54 to the hubcap 30.

As may be seen in the embodiment of FIG. 4, the rotor body 54 may be disposed inside the hubcap 30 and be accessible from the outer face 402 of the hubcap 30 through a vent orifice 404. A vent plug 406 may be disposed in the vent orifice 404. A vent channel 408 provides a pathway for pressurized fluid to escape from the interior 48 of the hubcap 30. A gland 410, such as an o-ring, may provide a one-way valve to seal the vent channel 408 from environmental contaminants.

Referring to FIG. 5, the rotor body 54 may in other embodiments be tapered to thread into a correspondingly tapered socket 500 forming a central bore of the hubcap 30. The rotor body 54 may be configured to seat in the tapered socket 500 of the hubcap 30 so as to ensure proper alignment of the one or more fluid ports 58 with the internal fluid channels 32 of the hubcap 30. The tapered socket 500 is configured such that seating the rotor body 54 into the tapered socket 500 is sufficient to align the fluid ports 58 with the internal fluid channels 32 of the hubcap 30. A tool receptacle 512 may be formed in the rotor body 54 and configured to receive a tool for removal of the rotor body 54 from the hubcap 30. One or more annular seals 514 may seal the rotor body 54 to the hubcap 30.

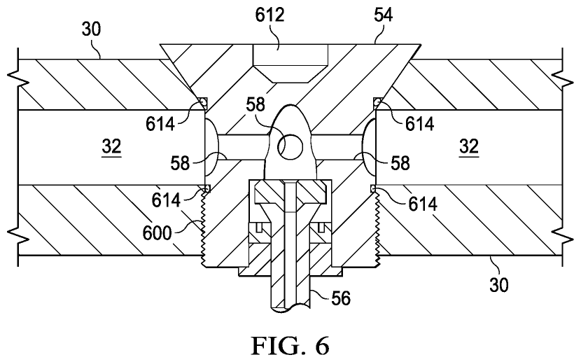

In yet other embodiments, such as seen in FIG. 6, the rotor body 54 may be tapered into a conical shape so as to self-seat the threaded portion into the hubcap 30 as the proximal end of the threaded portion maintains a conical shape. The rotor body 54 may be configured to seat in the socket 600, which in this embodiment is threaded, forming a central bore of the hubcap 30 so as to ensure proper alignment of the fluid ports 58 with the internal fluid channels 32 of the hubcap. The threads may mate to a threaded socket 600 in the hubcap 30. In various embodiments, the rotor body 54 may be configured with a tool receptacle 612 to receive common automotive tools, such as screwdrivers, socket wrenches and hex wrenches. One or more annular seals 614 may seal the rotor body 54 to the hubcap 30.

One or more ports 58 in the rotor body 54 may be sealed to the central bore of the hubcap 30 by annular seals, o-rings, gaskets, or other mechanical seals disposed at or adjacent to edges of the hubcap 30 where the hubcap engages with the threaded portion. The seals may be disposed so as to seal the ports 58 in alignment with internal fluid channels 32 in the hubcap 30.

The rotary union may be used in connection with a tire inflation system, such as an automatic tire inflation system made by Pressure Systems International, Inc. Of course, the disclosed rotary union may be used with any other suitable tire inflation system, whether for sealed axles or unsealed axles, solid or hollow, or trailer, drive or steer axles. In the embodiment illustrated in FIG. 1, pressurized fluid (which may, for example, be air, nitrogen and/or other tire pressurizing fluid) may flow from a pressure source through a conduit to a pressure regulator, which may adjust the pressure of the fluid to a pressure suitable for tire inflation, such as 110 psi. The fluid may flow from the pressure regulator 68 through conduit to axle. The fluid may flow through the axle to the stator. A filter may remove particles from the fluid before the fluid enters the stator. The fluid may flow through the stator 18 into the tube of the rotary union assembly. The fluid may flow from the rotary union assembly through the fluid channels to hoses connected to the hubcap via fittings. The hoses may be connected to tire valves so as to allow fluid to flow into tires (not shown).

Thus, the rotary union may allow pressurized fluid to flow from the pressure source to the tires regardless of whether the vehicle is moving. The hubcap and part of the rotary union assembly may rotate with the vehicle tire (not shown), which may be mounted to a wheel (not shown) mounted to the hub 14.

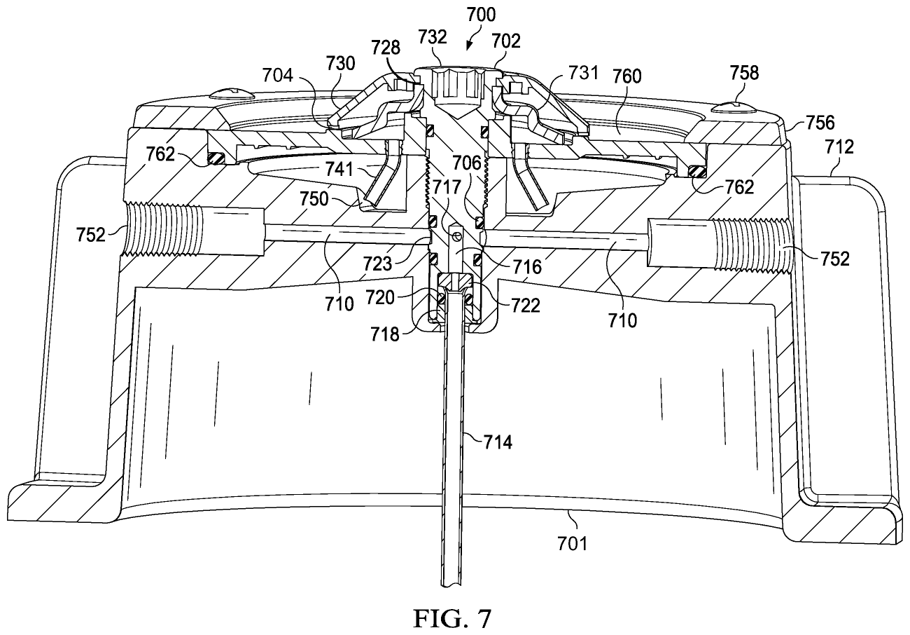

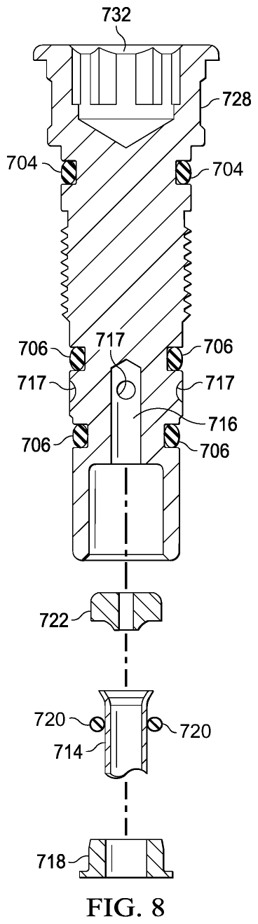

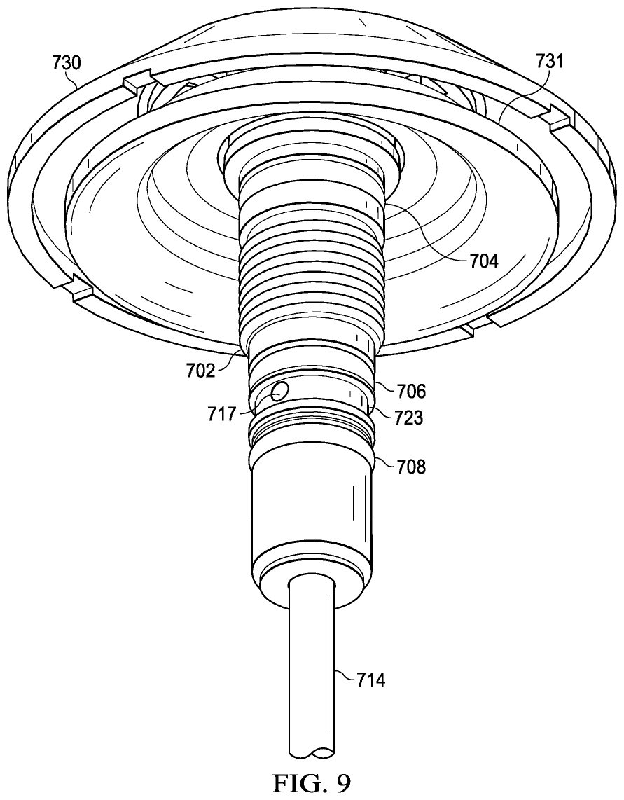

In another embodiment, as seen in FIGS. 7-9, the rotary union 700 may comprise a rotor body 702 having a plurality of seals disposed thereon. A first seal 704 may be disposed on the rotor body 702 near where the rotary union 700 abuts a sight glass 760 forming the outboard face of the hubcap 701. The first seal 704 seals the rotor body 702 to a sight glass 760. A second seal 706 may be disposed adjacent to the one side of one or more fluid channels 710 disposed in the hubcap 701 while a third seal 708 is on the other side of the fluid channels 710. In the disclosed embodiment, the outboard face of the hubcap is formed primarily by a sight glass 760 sealed to the hubcap by an annular seal 762 and retained against the hubcap 701 by a retaining ring 756 fixed to the hubcap by one or more fasteners 758. However, the outboard face may comprise any solid surface sealing or enclosing the outside or free end of the hubcap. The outboard face may be formed as a unitary item of manufacture with the hubcap body, or may be a separate cover or disc removably or permanently mountable to the hubcap body.

The rotor body 702 may be removably disposed in the hubcap 701. In some embodiments, the rotor body 702 may comprise one or more threaded portions that may be used to mount the rotary union 700 to a hubcap having corresponding threaded portions. In the embodiment of FIG. 7, the threaded portion may comprise NPT threading. However, straight threading may be used as well. Of course, any other suitable mounting means may be provided, such as keys and slots, friction fit, adhesive, crimping, and the like.

The rotor body 702 comprises a ported fluid chamber 716. The fluid chamber 716 includes one or more ports 717 disposed about the wall of the chamber so as to provide fluid communication between the fluid chamber 716 and an outer surface of the rotor body 702. In some embodiments, the one or more ports 717 may align with one or more fluid channels 710 of the hubcap. The number of ports 717 may be equal to the number of fluid channels in the hubcap or may be more or less in number than the number of fluid channels in the hubcap. In some embodiments, the rotor body 702 may include a fluid groove 723 about the outer diameter of the rotor body 702 to provide fluid communication among the ports 717 about the exterior of the rotor body 702. Such a fluid groove may permit the rotor body 702 to be coupled to the hubcap without requiring alignment of ports 717 with the fluid channels 710 of the hubcap, or correspondence in the number of ports 717 and fluid channels 710. In such embodiments, when the rotor body is installed in the hubcap, fluid may flow from the ports of the rotor body and through the fluid groove to the fluid channels of the hubcap. Seals 706, 708 may be disposed about the rotor body so as to prevent pressurized fluid from the ports 717 from leaking into the interior of the hubcap.

The rotor body 702 may extend past the outboard face of the hubcap so as to offer a shoulder 728 that is exposed past the hubcap. A vent shield 730 may be mounted to the shoulder 728 to cover one or more fluid vent tubes 741 disposed in the hubcap. The vent shield may be at least partially or wholly rigid. The vent tubes may be straight, curved or bent, and are provided to permit release of pressure from the interior of the hubcap to atmosphere. The fluid channels walls may include a notch 750, groove, or other indentation as may be desired to accommodate a vent tube.

A flexible flapper 731 may be disposed under the vent shield to seal the vent tubes from external contamination, such as dust and water. The flapper may be disc-shaped and formed of a rubber or rubber-like material. If pressure begins to increase in the interior of the hubcap, then the pressure may flow through the vent tubes and lift the flapper 731 sufficient to allow pressurized fluid to escape to atmosphere. In some embodiments, pressurized fluid escaping past the flapper will cause the flapper to vibrate noisily and alert the driver of a potentially dangerous wheel-end condition.

The rotor body may also include at an outer end a recessed tool receptacle 732 at which a wrench, screwdriver, or other appropriate tool may be used to tighten or loosen the rotor head from the hubcap.

The rotary union may also further comprise a tube or tubular member 714 assembled to an inner end of the rotor body 702 by a telescope cap 718. The inner end of the rotor body may include an opening configured to receive the tube 714 and annular seal 720.

The telescope cap 718 may be mounted to the rotor body 702 by any suitable means, such as friction fit, screw threads, adhesive or crimping, etc. The tube 714 may comprise a flared end that may be disposed within the fluid chamber 716. The flared end may prevent the tube 714 from sliding out of the telescope cap 718. The central bore of the hubcap may be configured as a blind socket (as illustrated) to receive the inner end of the rotor body, thus ensuring alignment of the ports 717 with the fluid channels 710 as well as providing additional retention of the telescope cap to the rotor body.

In other embodiments, the central bore may be open so as to permit the inner end of the rotor body to extend freely into the interior of the hubcap. In such embodiments, the shoulder 728 of the rotor body may limit insertion of the rotor body in the central bore to a point at which the ports 717 will align with the fluid channels 710. Alignment of the ports with the fluid channels need not be exact, and need only be sufficient for fluid flow.

A bearing 722 may be disposed between a lip 124 of the rotor body 702 and the flared end of the tube 714. The bearing may comprise any suitable material, such as graphite, nylon, oilite, Delrin, brass or any other material suitable for reducing wear or friction between the tube 714 and the rotor body 702. The tube 714 may be sealed to the rotor body 702 by an annular seal 720. The annular seal 720 may be an o-ring, lip seal or any other suitable seal configuration, and may comprise a variety of materials, such as rubber, silicone, nylon, oilite or graphite. The tube 714 may rotate within either or both of the seals of a stator (located in the axle press plug) and the rotary body.

The tube 714 may comprise any suitable material or combination of materials, and may be rigid, flexible, or both. For example, tube 714 may comprise steel, brass, nylon, polycarbonate, acrylic, rubber, or any combination thereof. For example, the flared end of the tube 714 may comprise a steel tubular portion.

Pressurized fluid may flow from the tube 714 to the fluid chamber 716, and from the fluid chamber 716 through the ports 717 into the fluid channels 710. Pressurized fluid may flow from the fluid channels 710 through hubcap ports 752 to pneumatic tires (not shown) through air hoses (not shown) providing a sealed fluid path from the hubcap ports 752 to the pneumatic tires. In some embodiments, the hubcap ports 752 may be protected by one or more wings 712 disposed on either side of the hubcap port. The wings 712 may serve to protect a hose fitting (not shown) disposed in the hubcap port from being damaged by impact.

The rotary unions formed by a rotor body and a tube are disclosed in the foregoing embodiments as formed by annular seals disposed so as to seal the rotor body to the tube. In some embodiments, the rotary union may comprise a face seal. In such embodiments, the end of the tube or tubular member disposed in the rotor body may have a steel or metal or other hard flat face. The rotor body may include a graphite bearing having a face configured to abut the face of the tubular member. The graphite bearing includes a central hole through which fluid may flow. The graphite member may be urged against the face of the tubular member by a spring. The tubular member and graphite bearing may rotate with respect to each other, and the interface of the two provides a substantially sealing surface through which pressurized fluid may pass. Such face seals may leak slightly, and so the rotor body may include a weep hole from which leaking fluid may pass into the interior of the hubcap. A hubcap vent, such as a vent plug or vent tubes, may serve to vent leaking fluid from the hubcap to atmosphere. The tubular member may be mounted in one or more bearings disposed in the rotor body to better maintain alignment of the tubular member face with the graphite bearing face.

Accordingly, various embodiments may be provided, including as described in the following numbered clauses:

1. A rotary union comprising a rotor body having a sealed first end and a second end forming a first fluid channel, the rotor body having a port extending therethrough to permit fluid to flow from the first fluid channel out of the rotor body; a tubular member having a first end sealingly and rotatably disposed in the first fluid channel at the second end of the rotor body; the rotor body being configured for removable disposition into the interior of a hubcap, the hubcap having an outboard face forming an orifice at the center thereof, the hubcap having a central bore disposed wholly in the hubcap interior and aligned with the orifice, the central bore being configured to receive the second end of the rotor body when the rotor body is introduced into the hubcap interior through the orifice, the hubcap comprising a second fluid channel extending from an exterior surface of the hubcap to the central bore; and the rotor body being further configured for disposition in the central bore such that the tubular member extends into the hubcap interior and fluid may flow from the port into the second fluid channel.

2. The rotary union of clause 1, the rotor body being further configured for disposition in the central bore such that the port is aligned with the second fluid channel.

3. The rotary union of clause 1, the rotor body comprising a groove formed about the exterior of the rotor body at the port such that when the rotor body is disposed in the central bore, fluid may flow from the port through the groove about at least a portion of the rotor body to the second fluid channel.

4. The rotary union of clause 1, the hubcap comprising a third fluid channel extending from an exterior surface of the hubcap to the central bore, the rotor body being further configured for disposition in the central bore such that fluid may flow from the port into the third fluid channel.

5. The rotary union of clause 4, the port comprising a first port, the rotor body further comprising a second port, the rotor body being further configured for disposition in the central bore such that fluid may flow from the second port into the third fluid channel.

6. The rotary union of clause 1, wherein the orifice is configured to receive a hubcap vent plug, and the rotor body is configured to be enclosed entirely by the hubcap when disposed in the central bore.

7. The rotary union of clause 6, wherein the sealed first end comprises a shoulder configured to engage the central bore so as to control the position of the rotor body in the central bore to align the port with the second fluid channel.

8. The rotary union of clause 7, wherein the shoulder is tapered, and the central bore comprises a tapered portion configured to receive the shoulder.

9. The rotary union of clause 6, wherein the central bore forms a blind socket, and the rotor body is configured to seat in the blind socket so as to align the port with the second fluid channel.

10. The rotary union of clause 6, wherein the central bore is open, and the rotor body is adjustably disposed in the central bore so as permit alignment of the port with the second fluid channel.

11. The rotary union of clause 6, wherein the central bore forms a blind socket, and the rotor body is configured to seat in the blind socket so as to align the port with the second fluid channel.

12. The rotary union of clause 6, wherein the central bore is fully tapered, and the rotor body is correspondingly tapered to seat in the central bore so as to align the port with the second fluid channel.

13. The rotary union of clause 1, the sealed first end forming an elongated portion configured to extend partially through the orifice, the elongated portion comprising a shoulder that remains outside the hubcap when the rotor body is disposed in the central bore.

14. The rotary union of clause 13 further comprising a vent shield mounted to the shoulder, the vent shield configured to cover vent tubes disposed in the outboard face of the hubcap.

15. The rotary union of clause 14, further comprising a flexible flapper disposed under vent shield, the flexible flapper configured for sealing contact with the outboard face of the hubcap so as to seal the vent tubes from entry of environmental contaminants into the hubcap interior.

16. The rotary union of clause 15, the elongated portion having a seal disposed thereon so as to seal the elongated portion to the outboard face of the hubcap.

17. The rotary union of clauses 1 and 13, further comprising a first annular seal disposed about the exterior of the rotor body on one side of the port; a second annular seal disposed about the exterior of the rotor body on another side of the port; and the first and second annular seals being configured to seal the rotor body to the central bore when the rotor body is disposed therein.

18. The rotary union of clause 17, the sealed end forming a tool receptacle.

19. The rotary union of clause 18, further comprising a third annular seal disposed in the first fluid channel, the first end of the tubular member sealingly disposed in the third annular seal so as to seal the tubular member to the rotor body.

20. The rotary union of clause 19, wherein the tube is rigid or flexible, or comprises a flexible portion and a rigid portion.

21. The rotary union of clause 20 further comprising a telescope cap disposed about the tube and fitted to the rotor body to retain the tube in the rotor body.

22. The rotary union of clause 21 wherein the first end of the tube is flared to so as to prevent translation of such end through the first annular seal and the telescope cap.

23. The rotary union of clause 22 further comprising a bearing disposed between the tube end and the rotor body, the bearing comprising a fluid passage to allow fluid to flow from the tube to the first fluid channel.

24. The rotary union of clause 23, the tubular member having a second end configured for sealing disposition in a fourth annular seal disposed in a stator such that fluid may flow from the stator through the tubular member and into the fluid channel of the rotor body.

25. The rotary union of clause 24, wherein the tubular member may rotate in either or both the third annular seal and the fourth annular seal.

26. The rotary union of any of the foregoing numbered clauses, wherein the annular seals comprise either a lip seal or an o-ring.

27. The rotary union of clause 17, wherein the tubular member is sealingly disposed in rotor body by a face seal.

28. The rotary union of clause 26, the first end of the tubular member comprising a steel face, the rotor body including a graphite bearing disposed in the first fluid channel, the graphite bearing comprising a face configured to rotatably abut the steel face so as to form the face seal.

29. A vehicle hubcap adapted for use with a tire inflation system, the hubcap comprising a round cap body forming a hollow interior, the cap body having a first end comprising a solid outboard face, the outboard face forming an orifice at the center thereof, the cap body having an open second end configured for removable mounting to a vehicle hub; a central bore disposed wholly within the hubcap interior and aligned with the orifice; a fluid channel extending from an exterior surface of the cap body to the central bore, the fluid channel being configured to connect to an air hose at the exterior surface; the central bore being configured to receive a rotary union when the rotary union is introduced into the hollow interior through the orifice, the rotary union comprising a rotor body and a tubular member sealingly and rotatably coupled to the rotor body, the rotor body having a port extending therethrough to permit fluid to flow from the rotor union; and the central bore being configured to receive the rotor body such that the tubular member extends into the hubcap interior and fluid may flow from the port of the rotor body to the fluid channel.

30. The hubcap of clause 29, the orifice being configured to receive a hubcap plug, the hubcap being configured to entirely enclose the rotor body by the hubcap when the rotor body is disposed in the central bore

31. The hubcap of clause 29, the rotor body having a sealed first end and a second end forming a first fluid channel, the first end of the tubular member being sealingly and rotatably disposed in the fluid channel at the second end of the rotor body, the sealed first end forming an elongated portion configured to extend partially through the orifice, the elongated portion comprising a shoulder that remains outside the hubcap when the rotor body is disposed in the central bore.

32. The hubcap of clause 31, further comprising vent tubes disposed in the outboard face so to permit pressurized fluid in the interior of the hubcap to escape to atmosphere, the rotor body further comprising a rigid vent shield mounted to the shoulder, the vent shield configured to cover the vent tubes.

33. The hubcap of clause 32, the rotor body further comprising a flexible flapper disposed under vent shield, the flexible flapper configured for sealing contact with the outboard face of the hubcap so as to seal the vent tubes from entry of environmental contaminants into the hubcap interior.

34. The hubcap of clause 33, the elongated portion having a seal disposed thereon. the outboard face of the hubcap being configured to sealingly engage the seal so as to seal the elongated portion to the outboard face.

35. A method of installing a rotary union in a hubcap, the rotary union comprising a fluid port, the hubcap comprising an outboard face having an orifice centrally formed therein, a plug removably disposed in the orifice, a central bore disposed in the interior of the hubcap and aligned with the orifice, and a fluid channel extending from the central bore to an exterior of the hubcap, the method comprising removing the plug from the orifice; inserting a rotary union through the orifice and advancing the rotary union into the central bore so as to align the fluid port with the fluid channel; and disposing the plug in the orifice.

36. The method of clause 35, the rotary union being the rotary union of clause 6 and the hubcap being the hubcap of clause 29.

37. The method of clause 36, the hubcap being mounted to a vehicle hub in turn mounted to an axle having a stator disposed therein, the method further comprising inserting the tubular member into the stator for sealing engagement therewith.

38. The method of clause 37 being performed while lubricant is contained in the hubcap.

39. The method of clause 38, the plug comprising a vent plug.

Although the disclosed subject matter and its advantages have been described in detail, it should be understood that various changes, substitutions and alterations can be made herein without departing from the subject matter as defined by the appended claims. Moreover, the scope of the present application is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. For example, although the disclosed apparatus, systems and methods may be described with reference to a manual or manually-activated pressure reduction valve, an electric valve or other automatic electronic or mechanical valve may be used to accomplish relatively rapid reduction of air pressure. Accordingly, the appended claims are intended to include within their scope such processes, machines, manufacture, compositions of matter, means, methods, systems or steps.

What is claimed is:

1. A rotary union comprising:
a rotor body having a sealed first end and a second end forming a first fluid channel, the rotor body having a port extending therethrough to permit fluid to flow from the first fluid channel out of the rotor body;
a tubular member having a first end sealingly and rotatably disposed in the first fluid channel at the second end of the rotor body;
the rotor body being configured for removable disposition into the interior of a hubcap, the hubcap having an outboard face forming an orifice at the center thereof, the hubcap having a central bore disposed wholly in the hubcap interior and aligned with the orifice, the central bore being configured to receive the second end of the rotor body when the rotor body is introduced into the hubcap interior through the orifice, the hubcap comprising a second fluid channel extending from an exterior surface of the hubcap to the central bore; and
the rotor body being further configured for disposition in the central bore such that the tubular member extends into the hubcap interior and fluid may flow from the port into the second fluid channel.

2. The rotary union of claim 1, the rotor body being further configured for disposition in the central bore such that the port is aligned with the second fluid channel.

3. The rotary union of claim 1, the rotor body comprising a groove formed about the exterior of the rotor body at the port such that when the rotor body is disposed in the central bore, fluid may flow from the port through the groove about at least a portion of the rotor body to the second fluid channel.

4. The rotary union of claim 1, the hubcap comprising a third fluid channel extending from an exterior surface of the hubcap to the central bore, the rotor body being further configured for disposition in the central bore such that fluid may flow from the port into the third fluid channel.

5. The rotary union of claim 4, the port comprising a first port, the rotor body further comprising a second port, the rotor body being further configured for disposition in the central bore such that fluid may flow from the second port into the third fluid channel.

6. The rotary union of claim 1, wherein the orifice is configured to receive a hubcap vent plug, and the rotor body is configured to be enclosed entirely by the hubcap when disposed in the central bore.

7. The rotary union of claim 6, wherein the sealed first end comprises a shoulder configured to engage the central bore so as to control the position of the rotor body in the central bore to align the port with the second fluid channel.

8. The rotary union of claim 7, wherein the shoulder is tapered, and the central bore comprises a tapered portion configured to receive the shoulder.

9. The rotary union of claim 6, wherein the central bore forms a blind socket, and the rotor body is configured to seat in the blind socket so as to align the port with the second fluid channel.

10. The rotary union of claim 6, wherein the central bore is open, and the rotor body is adjustably disposed in the central bore so as permit alignment of the port with the second fluid channel.

11. The rotary union of claim 6, wherein the central bore forms a blind socket, and the rotor body is configured to seat in the blind socket so as to align the port with the second fluid channel.

12. The rotary union of claim 6, wherein the central bore is fully tapered, and the rotor body is correspondingly tapered to seat in the central bore so as to align the port with the second fluid channel.

13. The rotary union of claim 1, the sealed first end forming an elongated portion configured to extend partially through the orifice, the elongated portion comprising a shoulder that remains outside the hubcap when the rotor body is disposed in the central bore.

14. The rotary union of claim 13 further comprising a vent shield mounted to the shoulder, the vent shield configured to cover vent tubes disposed in the outboard face of the hubcap.

15. The rotary union of claim 14, further comprising a flexible flapper disposed under vent shield, the flexible flapper configured for sealing contact with the outboard face of the hubcap so as to seal the vent tubes from entry of environmental contaminants into the hubcap interior.

16. The rotary union of claim 15, the elongated portion having a seal disposed thereon so as to seal the elongated portion to the outboard face of the hubcap.

17. The rotary union of claims 1 and 13, further comprising:
a first annular seal disposed about the exterior of the rotor body on one side of the port;
a second annular seal disposed about the exterior of the rotor body on another side of the port; and
the first and second annular seals being configured to seal the rotor body to the central bore when the rotor body is disposed therein.

18. The rotary union of claim 17, the sealed end forming a tool receptacle.

19. The rotary union of claim 18, further comprising a third annular seal disposed in the first fluid channel, the first end of the tubular member sealingly disposed in the third annular seal so as to seal the tubular member to the rotor body.

20. The rotary union of claim 19, wherein the tube is rigid or flexible, or comprises a flexible portion and a rigid portion.

21. The rotary union of claim 20 further comprising a telescope cap disposed about the tube and fitted to the rotor body to retain the tube in the rotor body.

22. The rotary union of claim 21 wherein the first end of the tube is flared to so as to prevent translation of such end through the first annular seal and the telescope cap.

23. The rotary union of claim 22 further comprising a bearing disposed between the tube end and the rotor body, the bearing comprising a fluid passage to allow fluid to flow from the tube to the first fluid channel.

24. The rotary union of claim 23, the tubular member having a second end configured for sealing disposition in a fourth annular seal disposed in a stator such that fluid may flow from the stator through the tubular member and into the fluid channel of the rotor body.

25. The rotary union of claim 24, wherein the tubular member may rotate in either or both the third annular seal and the fourth annular seal.

26. The rotary union of any of the foregoing claims, wherein the annular seals comprise either a lip seal or an o-ring.

27. The rotary union of claim 17, wherein the tubular member is sealingly disposed in rotor body by a face seal.

28. The rotary union of claim 26, the first end of the tubular member comprising a steel face, the rotor body including a graphite bearing disposed in the first fluid channel, the graphite bearing comprising a face configured to rotatably abut the steel face so as to form the face seal.

29. A vehicle hubcap adapted for use with a tire inflation system, the hubcap comprising:
a round cap body forming a hollow interior, the cap body having a first end comprising a solid outboard face, the outboard face forming an orifice at the center thereof, the cap body having an open second end configured for removable mounting to a vehicle hub;
a central bore disposed wholly within the hubcap interior and aligned with the orifice;
a fluid channel extending from an exterior surface of the cap body to the central bore, the fluid channel being configured to connect to an air hose at the exterior surface;
the central bore being configured to receive a rotary union when the rotary union is introduced into the hollow interior through the orifice, the rotary union comprising a rotor body and a tubular member sealingly and rotatably coupled to the rotor body, the rotor body having a port extending therethrough to permit fluid to flow from the rotor union; and
the central bore being configured to receive the rotor body such that the tubular member extends into the hubcap interior and fluid may flow from the port of the rotor body to the fluid channel.

30. The hubcap of claim 29, the orifice being configured to receive a hubcap plug, the hubcap being configured to entirely enclose the rotor body by the hubcap when the rotor body is disposed in the central bore.

31. The hubcap of claim 29, the rotor body having a sealed first end and a second end forming a first fluid channel, the first end of the tubular member being sealingly and rotatably disposed in the fluid channel at the second end of the rotor body, the sealed first end forming an elongated portion configured to extend partially through the orifice, the elongated portion comprising a shoulder that remains outside the hubcap when the rotor body is disposed in the central bore.

32. The hubcap of claim 31, further comprising vent tubes disposed in the outboard face so to permit pressurized fluid in the interior of the hubcap to escape to atmosphere, the rotor body further comprising a rigid vent shield mounted to the shoulder, the vent shield configured to cover the vent tubes.

33. The hubcap of claim 32, the rotor body further comprising a flexible flapper disposed under vent shield, the flexible flapper configured for sealing contact with the outboard face of the hubcap so as to seal the vent tubes from entry of environmental contaminants into the hubcap interior.

34. The hubcap of claim 33, the elongated portion having a seal disposed thereon. the outboard face of the hubcap being configured to sealingly engage the seal so as to seal the elongated portion to the outboard face.

35. A method of installing a rotary union in a hubcap, the rotary union comprising a fluid port, the hubcap comprising an outboard face having an orifice centrally formed therein, a plug removably disposed in the orifice, a central bore disposed in the interior of the hubcap and aligned with the orifice, and a fluid channel extending from the central bore to an exterior of the hubcap, the method comprising:
removing the plug from the orifice;
inserting a rotary union through the orifice and advancing the rotary union into the central bore so as to align the fluid port with the fluid channel; and
disposing the plug in the orifice.

36. The method of claim 35, the rotary union being the rotary union of claim 6 and the hubcap being the hubcap of claim 29.

37. The method of claim 36, the hubcap being mounted to a vehicle hub in turn mounted to an axle having a stator disposed therein, the method further comprising inserting the tubular member into the stator for sealing engagement therewith.

38. The method of claim 37 being performed while lubricant is contained in the hubcap.

39. The method of claim 38, the plug comprising a vent plug.
